(19) United States
(12) Patent Application Publication
(10) Pub. No.: US 2024/0363090 A1
(43) Pub. Date: Oct. 31, 2024

(54) ADHESIVE GUITAR PICK GRIPS

(71) Applicant: Robert Stephen Hoover, Vestal, NY (US)

(72) Inventor: Robert Stephen Hoover, Vestal, NY (US)

(21) Appl. No.: 18/306,545

(22) Filed: Apr. 25, 2023

Related U.S. Application Data
(60) Provisional application No. 63/314,163, filed on Feb. 25, 2022.

(51) Int. Cl. G10D 3/173

(52) U.S. Cl. CPC G10D 3/173

(57) ABSTRACT

A reusable guitar pick grip pad has a resilient unitary body including a planar base having multiple grip protrusions and a reusable adhesive that does not leave residue on a substrate when removed. The reusable grip pad is removably affixed to the guitar pick with a reusable adhesive layer. The grip pad makes it much easier to maintain a guitar pick in the perfect playing position between the fingers with less finger pressure, enabling more control, comfort and playing accuracy with less fatigue in the strumming hand.

### CROSS-REFERENCE TO RELATED APPLICATION

This application claims the benefit of priority of U.S. provisional application No. 63/314,163, filed Feb. 25, 2022, the contents of which are herein incorporated by reference.

### BACKGROUND OF THE INVENTION

The present invention relates to guitar picks and, more particularly, to adhesive guitar pick grips.

Guitar players often have trouble keeping their guitar pick in proper position between their fingers, making it difficult to play well, or they drop the pick completely. This problem is made worse by afflictions such as carpal tunnel syndrome, arthritis, injury, or very dry or very sweaty fingers.

Currently available pick grips are too small to be effective and limit exactly where you can grip the pick, reducing the player's options of how to hold the pick; too thick and/or hard to be comfortable; and/or too sticky to enable position shifts when desirable. Some deteriorate after some use. Some slip over the pick so they are quite bulky, then begin to stretch and fit loosely after some use. None of the currently available products are durable, removable, and reusable all at once.

As can be seen, there is a need for a large, comfortable, durable, removable, and reusable pick grip that provides better grip to the skin without a sticky surface that adheres to the skin.

### SUMMARY OF THE INVENTION

In one aspect of the present invention, a reusable guitar pick grip pad comprises a resilient unitary body comprising a planar base having a plurality of grip protrusions and a reusable adhesive that does not leave residue on a substrate when removed.

In another aspect of the present invention, a reusable grip pad on a guitar pick comprises a resilient unitary body comprising a planar base having a plurality of grip protrusions removably affixed to the guitar pick with a reusable adhesive layer.

The combined result of these advantages is a more confident and accurate playing experience without the distractions of trying to control the pick as one plays. A guitar player can control their pick with far less finger pressure than before, enabling a more relaxed and accurate performance and renewed playing ability for those afflicted with injury or ailments that impair a strumming hand's gripping force, endurance, or sense of feeling.

The inventive pick grip makes it much easier to maintain perfect pick position between the fingers with less finger pressure, causing less fatigue in the strumming hand than prior art grips and enabling the player to play longer.

Guitar picks are also used by bass guitar, mandolin, ukulele, autoharp, and other stringed instrument players, so the adhesive grips of the present subject matter may be used by players of other stringed instruments as well.

The soft silicone rubber material is easy to trim to smaller or different shapes if the player uses small or odd shaped picks.

This adhesive grip may be stuck to anything that might be slippery or benefit from a surer grip, such as a butter dish or a hand tool.

These and other features, aspects and advantages of the present invention will become better understood with reference to the following drawings, description, and claims.

### BRIEF DESCRIPTION OF THE DRAWINGS

FIG. 1 is a front perspective view of an adhesive guitar pick grip according to an embodiment of the present invention;

FIG. 2 is an exploded perspective view thereof;

FIG. 3 is a side elevation view thereof;

FIG. 4 is a cross-sectional view, taken along line 4-4 of FIG. 3;

FIG. 5 is a front elevational view thereof; and

FIG. 6 is a front perspective view of an adhesive guitar pick grip according to another embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a guitar pick grip that adheres onto a flat guitar pick to add a uniquely controllable, yet position shiftable, comfortable, soft, durable, washable, and reusable guitar pick surface.

The grip may have a unitary body including a base having tiny posts or protrusions that grip the player's fingers without any residue. The grip protrusions do not stick to the skin, which is undesirable for shifting the pick position in one's fingers. Slippery finger sweat is channeled between the posts and away from the skin. The grip may be manufactured of any soft material that does not stick to skin, does not leave residue, does not deteriorate with use, and is strong and resilient enough to resist tearing due to deformation in the process of removal from a pick. The grip remains intact when peeled off a pick or other surface. For example, the grip may be manufactured of silicone rubber.

When the user adheres a grip onto a pick, it does not slip or fall off the pick. It remains in place until the user peels it off, e.g., to reuse the grip on a new pick when the old one wears out. This can be done a few times with each grip until the adhesive backing is no longer effective, making the grips very affordable per guitar pick use.

The adhesive grip may be manufactured by injection molding food grade silicone to create a base with the unique “tiny grippy posts” protruding therefrom. The grip pads have a reusable adhesive backing applied to the back surface, opposite the surface with protrusions, to enable adherence to a flat guitar pick. The adhesive material stays on the grip and not on the surface from which it has been removed. For example, a one-piece molded food grade silicone rubber grip may have an acrylic adhesive layer such as 3M® part number 300LSE.

The grips are configured to fit on the wide end of a standard guitar pick all the way to the edges, with a margin of about 1/16″ at the edges. The base covers most of the pick surface area to provide comfortable pick control and grip flexibility that enables better playing control, accuracy, and performance for the stringed instrument musician. For example, the grip may cover about 50% to about 75% of the pick surface area. The dimensions of the grip may be, e.g., about 1″ L×about ¾″ W. The overall thickness may be about 0.6 mm to about 0.8 mm. The protrusions may be any suitable shape in any suitable evenly spaced pattern. For example, the protrusions may be cylindrical in shape with a height generally less than or equal to the thickness of the base, e.g., about 0.3 mm, i.e., about 37% to 50% of the overall thickness. The number of protrusions is not particularly limited. For example, the grip may have about 330 protrusions per square inch.

To use the inventive pick, the player may peel one grip off at a time from a plastic backer sheet and stick it onto one side of his or her favorite flat guitar pick. The user may also apply a grip to the other side of the pick. Most players seem to like them on both sides of the pick but some prefer only using a grip on one side for less overall thickness. If the grip is larger than or differently shaped from the pick, or if the player prefers a smaller size, the grip may be trimmed using scissors or a razor blade. The player may then use the pick to play an instrument in the same way as the player would do so without the grips.

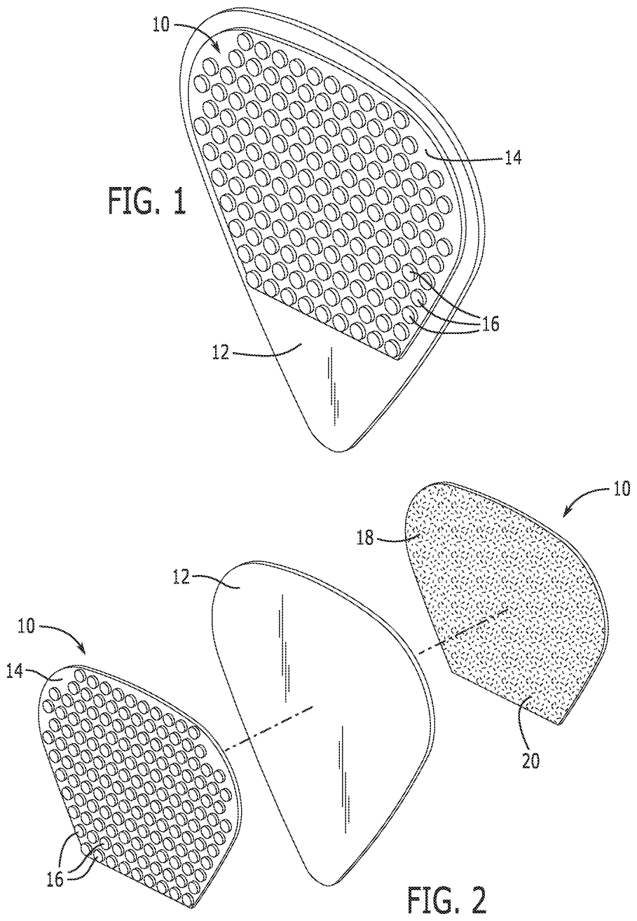

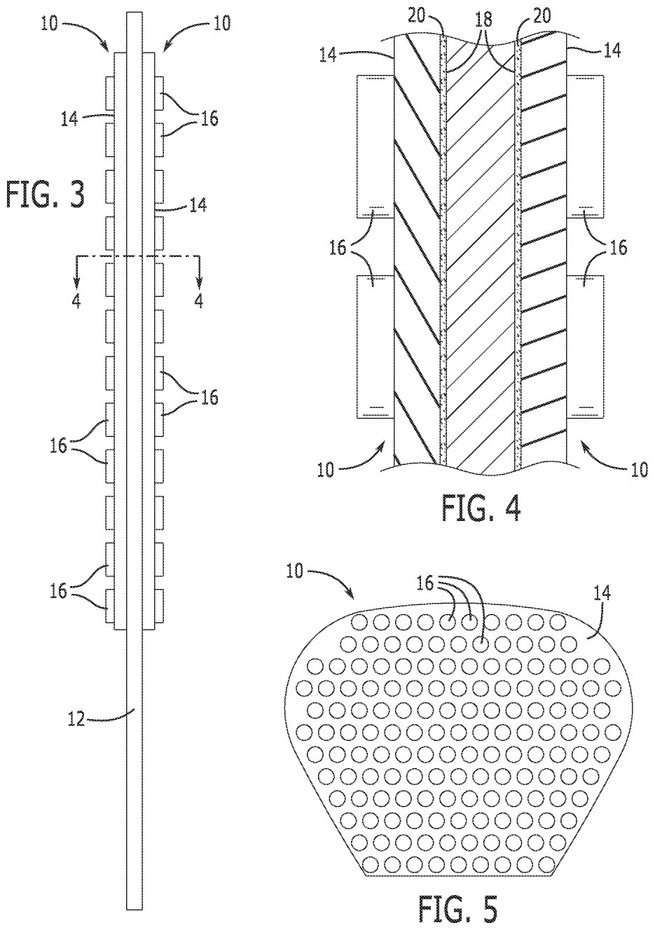

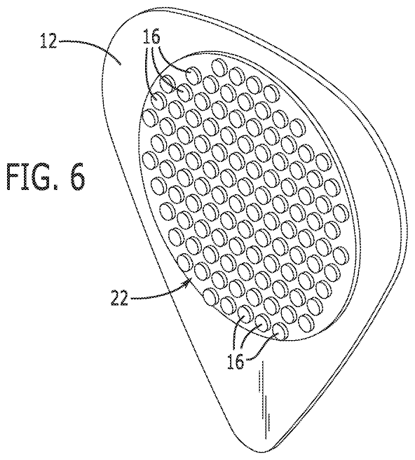

Referring to FIGS. 1 through 6, FIG. 1 illustrates an adhesive guitar pick grip 10 according to an embodiment of the present invention adhered to a guitar pick 12. A front face 14 of the grip 10 has a plurality of grip protrusions 16, while a rear surface 18 of the grip 10 has a reusable adhesive 20. The grip 10 may have a truncated triangular shape with rounded corners or a circular shape, such as the grip 22 shown in FIG. 6.

It should be understood, of course, that the foregoing relates to exemplary embodiments of the invention and that modifications may be made without departing from the spirit and scope of the invention as set forth in the following claims.

What is claimed is:

1. A reusable guitar pick grip pad, comprising:
a resilient unitary body comprising a planar base having a plurality of grip protrusions and
a reusable adhesive that does not leave residue on a substrate when removed.

2. The reusable guitar pick grip pad of claim 1, wherein the resilient unitary body is formed of silicone rubber.

3. The reusable guitar pick grip pad of claim 1, wherein the reusable adhesive is an acrylic adhesive.

4. The reusable guitar pick grip pad of claim 1, wherein the protrusions are cylindrical.

5. The reusable guitar pick grip pad of claim 1, wherein the protrusions have a height of about 37.5% to about 50% of an overall pad thickness.

6. The reusable guitar pick grip pad of claim 1, characterized by a truncated triangular shape with rounded corners.

7. The reusable guitar pick grip pad of claim 1, characterized by a circular shape.

8. On a guitar pick, a reusable grip pad comprising a resilient unitary body comprising a planar base having a plurality of grip protrusions removably affixed to the guitar pick with a reusable adhesive layer.

9. The reusable grip pad of claim 8, wherein the reusable grip pad covers about 50% to about 75% of a surface area of the guitar pick.
